(19) United States
(12) Patent Application Publication
(10) Pub. No.: US 2014/0095356 A1
(43) Pub. Date: Apr. 3, 2014

(54) Enhanced Microgift System and Method of Operation

(71) Applicant: WEYENOT, INC., (US)

(72) Inventor: Jon Kepecs, Woodside, CA (US)

(73) Assignee: WEYENOT, INC., Menlo Park, CA (US)

(21) Appl. No.: 13/743,192

(22) Filed: Jan. 16, 2013

Related U.S. Application Data
(60) Provisional application No. 61/586,913, filed on Jan. 16, 2012.

(51) Int. Cl. G06Q 30/06

(52) U.S. Cl. CPC G06Q 30/0617
USPC 705/26.43

(57) ABSTRACT

A computer system implements a gifting service where a gift of a specific item is validated as a result of the gift recipient requesting a validation code be delivered to the merchant for confirmation. The validation code can be a code defined by the gift recipient or the code management system, and may include credit card PAN's, ordinary codes, or pictures of the gift recipient. Enhancements to assist merchants in certifying training of employees are also provided.

### CROSS-REFERENCE TO RELATED APPLICATIONS

This patent application claims priority to Provisional Patent Application No. 61/586,913, entitled, “Enhanced Methods for Microgift System and Method of Operation,” and filed Jan. 16, 2012.

### BACKGROUND OF THE INVENTION

In today's world of social networking, it is commonplace to offer virtual gifts (e.g., an image of a flower or a cupcake) that can be ‘sent’ to a user, perhaps to celebrate an event or act as a ‘thank you’ notification. Other forms of real gifts are largely limited to forms of gift certificate. The present invention is directed toward real gifts, generally of small value (microgifts), although not necessarily so limited, and which represent specific items available at specific merchants (a merchant could be a real brick-and-mortar merchant or a web merchant).

U.S. Provisional Appln. No. 61/568,825, filed Dec. 9, 2011 and entitled, “Microgift System and Method of Operation,” now U.S. patent application Ser. No. 13/710,309, and assigned to present assignee, described a system and method for implementing a gift delivery system. The application also relied upon methods described in U.S. Provisional Appln. No. 61/487,886, filed May 19, 2011 and entitled “Customer Loyalty System and Method of Operation,” now U.S. patent application Ser. No. 13/477,010, and also assigned to the present assignee, for gift validation. The present application, describes additional enhancements to the aforementioned system, and in particular, describes an enhanced mechanism for validating gifts (that is, proving to the merchant that a gift is owned by a giftee and for managing the secure redemption of that gift).

Validation mechanisms for proving that a customer is entitled to a specific gift from a merchant include the use of an Internet-connected device available at the merchant. Such a device might be a standalone device, such as a tablet computer with a wireless connection; an Internet-connected phone, an ordinary workstation computer, or the point of sale (POS) computer which is often connected to the Internet for such purposes as inventory management or simply to do credit card processing via a gateway to the credit card processing network.

Other mechanisms, such as using a cryptographic token were also described in the aforementioned U.S. Provisional Application No. 61/487,886. While tokens present a paperless solution, they suffer from drawbacks, such as: 1) the requirement that (often long) strings of numbers be compared, which is error-prone, and timer constraints of new token generation can result in the need for multiple attempts to validate; 2) the fact that if there are multiple POS terminals, each employing a token, the individual challenge response associated with that token must be specified (that is, the identity of the token must be considered if there are multiple tokens in the same location); 3) the lack of merchant confirmation of issuing a gift (the token has no logic beyond displaying the current challenge response, so the ability to explicitly indicate the redemption of an item is curtailed with simple tokens); 4) the lack of an audit trail available to the merchant on each redemption; 5) the cost of physical tokens; 6) the management of lost tokens and time to deliver initial tokens; 7) the problems of token synchronization, such as timer-based tokens regenerating challenge codes before the current code is validated, or getting the clock out of synchronization, or for explicit challenge code tokens being used too often without coordinating with a central server such that the response no longer matches the challenge; and 8) particular problems, such as the inadvertent generation of a code by a gift claimant. The gift is recorded as issued even though the claimant is not necessarily present at the merchant site. While there are techniques to mitigate this problem, they do not completely solve the problem of merchant confirmation, which is needed in case, for example, the merchant is out of stock for the item in question.

The system and method of operation described in the present application overcomes these problems. Internet-connected devices are employed at the merchant. A technique for training merchants and their employees in the deployment of the system described in the present invention is also described.

### BRIEF SUMMARY OF THE INVENTION

The present invention provides for a computer system for implementing a gift validation service where a gift is purchased by a first party for a second party to be redeemed from a third party. The computer system comprises at least one processor coupled to at least one memory wherein the at least one processor is programmed to manage the validation of gifts purchased through the computer system by: receiving a request from the second (or first) party to send a second party identification code for the gift to the third party; sending an identification code for the second party to the third party; receiving an indication from the third party that the gift has been redeemed; and preparing remuneration to the third party.

The present invention also provides for a method for a gift validation service where a gift is purchased by a first party for a second party to be redeemed from a third party. The method comprises the steps of receiving a request through a computer network from the second (or first) party to send a second party identification code for the gift to the third party; generating, using at least one computer processor, an identification code for the second party to the third party and sending the identification code for the second party to the third party; receiving an indication from the third party that the gift has been redeemed; and preparing remuneration to the third party.

The present invention further provides for a non-transitory computer-readable storage medium with an executable program stored thereon for validating gifts where a gift is purchased by a first party for a second party to be redeemed from a third party, wherein the program instructs at least one processor to perform the following steps: receiving a request from the second (or first) party to send a second party identification code for the gift to the third party; sending an identification code for the second party to the third party; receiving an indication from the third party that the gift has been redeemed; and preparing remuneration to the third party.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows the process by which a first person (the giftor) purchases an item for a second person (giftee) utilizing the code management system according to one embodiment of the present invention.

FIG. 2 shows the process of FIG. 1, but that code comprises a PAN (Primary Account Number) in this case.

FIG. 3 illustrates at a general level a process by which a first person (the giftor) purchases an item for a second person (giftee) utilizing the code management system according to one embodiment of the present invention.

### DETAILED DESCRIPTION OF THE INVENTION

Some systems, such as described in U.S. Pat. Appln. Pub. No. 2012/0095916, published Apr. 19, 2012 and entitled “Payment Methods with a Payment Service and Tabs Selected by a First Party and Opened by a Second Party at any Geographic Location of the First Party's Mobile Device,” involve the transmission of information about a first party wishing to pay a second party. A financial account is linked to the first party and the first party is required to be within a defined geographical region. The second party, who receives payment, provides the amount of payment which is then confirmed to the first party. A third party manages the transmission of codes and provides payment services to the second party, typically via the services of a financial institution, such as a credit card processing bank.

In the system of the present invention, no financial account need be involved, geographical proximity is an optional requirement, and the amount of the transaction for a specific purchase item need not be provided by the second party. The item is predefined. That is, the present system is not a general payment vehicle, but rather, a means of validating a specific item to be delivered or made available to the first party where this item was previously defined prior to the interaction of the first and second parties. Furthermore, in the present system, there are four entities involved, not three: the first party (termed the giftee), the second party (termed the merchant), the third party who manages code transmission (termed the code manager) and a fourth party who actually purchases the item in question (termed the giftor). It should be noted that the giftee might be a customer of the merchant prior to receiving the gift from the giftor; from the merchant's standpoint the giftee might remain or become a customer after the transaction. “Merchant” is used to denote a retail establishment, a chain of such establishments, its owner(s)/management and employee(s) store depending upon context; however, the invention's primary focus is on small stores with a proprietor and a small number of employees, if any.

In one embodiment of the present system, there is no financial institution involved, as the code manager involvement in validating the item in question and subsequently remunerating the merchant is all that is required to complete the transaction. In another embodiment of the present system, the code transmitted to the merchant includes payment information, such as a credit card number (Primary Account Number or PAN) or bank account number which the merchant may input manually into a processing subsystem (such as a credit card processing system) or which can be automatically transmitted to such a processing subsystem.

The merchant should trust the data returned by the code manager; the system is secure since the giftee only requests that the code manager return a code to authenticate with to the merchant; if the giftee is not entitled to a gift (as determined for example by establishing giftee credentials upon logging in), the code manager will not deliver a confirmatory code to the merchant.

### System Organization And Operation

The present system is implemented with a merchant computer system and a gift management computer system, the backend system, for the code manager. The giftee and giftor can use Internet-connected devices at the merchant, or personal communications devices, such as cell phones or smart phones.

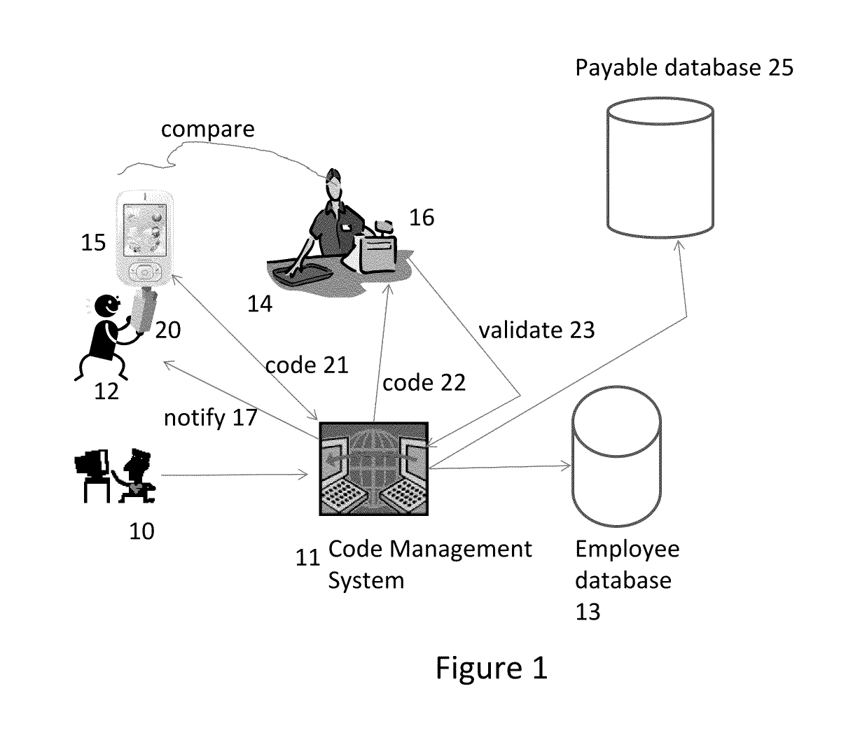

FIG. 1 depicts one embodiment of the invention. A giftor 10 purchases a gift via code management system 11 for a designated giftee 12 who is notified 17 of the gift 20 at a merchant 14 by the code management system 11 (of the gift management computer system) via email, text, social network, or other means. If the giftee is a merchant employee (described below in the Employee and Merchant Training section), this fact is recorded in an employee database 13. The giftee 12 visits merchant 14 in order to redeem the gift 20. The giftee 12 then employs an Internet-connected device 15 to communicate with the code management system 11, either to deliver a specified code 21, or to request a code be generated. The code 21 is communicated to both merchant (code 22) Internet-connected device 16 and giftee device 15 (if the giftee supplied the code, only the merchant device 16 is communicated with). The code 22 may be identical to the code 21, or may be indicative of the code 21 (e.g., the code 22 can be a picture of giftee 12). The code 22 also includes a description of the gift to which the giftee 12 is entitled. The merchant 14 requests the giftee 12 to display or tell them the code (or, if the code is a picture of giftee 12, the merchant 14 simply compares the picture of the code 22 to the actual giftee 12) and if the merchant code version 22 matches the giftee version of code 21, the merchant 14 grants delivery of gift 20 to giftee 12. The merchant 14 then communicates with the code management system 11 using Internet-connected device 16 to validate the gift 20 and provides gift 20 to the giftee 12. The code management system 11 then records a payable due the merchant 14 in a payable database 25 and then the gift management computer system delivers a check, wire transfer, or other means of remuneration to the merchant 14.

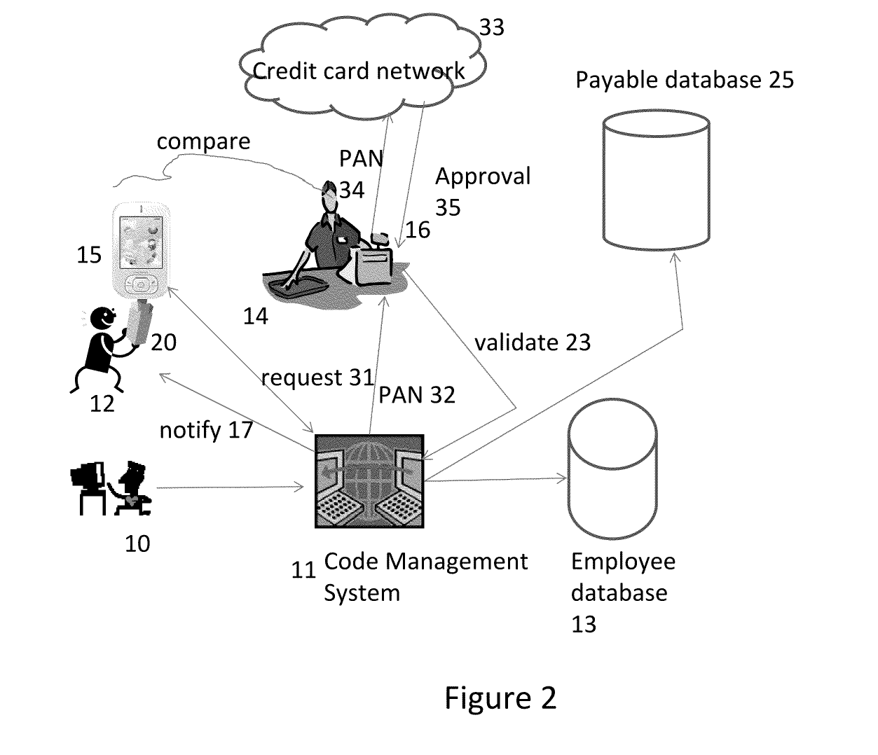

FIG. 2 depicts another embodiment of the invention similar to that illustrated in FIG. 1. As described above, a giftor 10 purchases a gift via the code management system 11 of the gift management system for a designated giftee 12 at a merchant 14. The giftee 12 is notified 17 of the gift at the merchant 14. But in this embodiment the giftee 12 requests that a credit card PAN (Primary Account Number) 32 be delivered to merchant Internet-connected device 16. This PAN is affiliated with the code management system 11. The merchant 14 then uses his POS terminal 16 (which is also his Internet-connected device) to request validation 31 of the PAN 34 (PAN 32 is the same as PAN 34, except PAN 34 is delivered to a credit card network 33 and the PAN 32 is delivered by the code management system 11) with the credit card network 33. The credit card network 33 validates that the PAN 34 is associated with sufficient funds for the gift 20 in question, and returns an authorization approval response 35 to the merchant POS terminal 16; the merchant then delivers the gift 20 to the giftee 12. In another embodiment of the invention, the giftee 12 could request that the PAN be delivered directly to Internet-connected device 15, such that this could be presented directly to merchant 14 for entry at POS system 16, thus circumventing the need for delivery of the PAN 32 to the merchant POS 16. Since the merchant is remunerated by the credit card system 33, there is no need for recording payables in the database 25 or arranging remuneration via the gift management computer system 11 as in FIG. 1. Note that the giftor 10 paid for the gift value, and that a PAN corresponding to this value is generated by the code management system 11 via contact with the credit card network 33. The PAN which is then delivered to the merchant POS terminal 16 for direct transmission, or to the merchant 14 for entry into merchant POS terminal 16, is affiliated with code management system 11, and not the giftee 12 nor giftor 10.

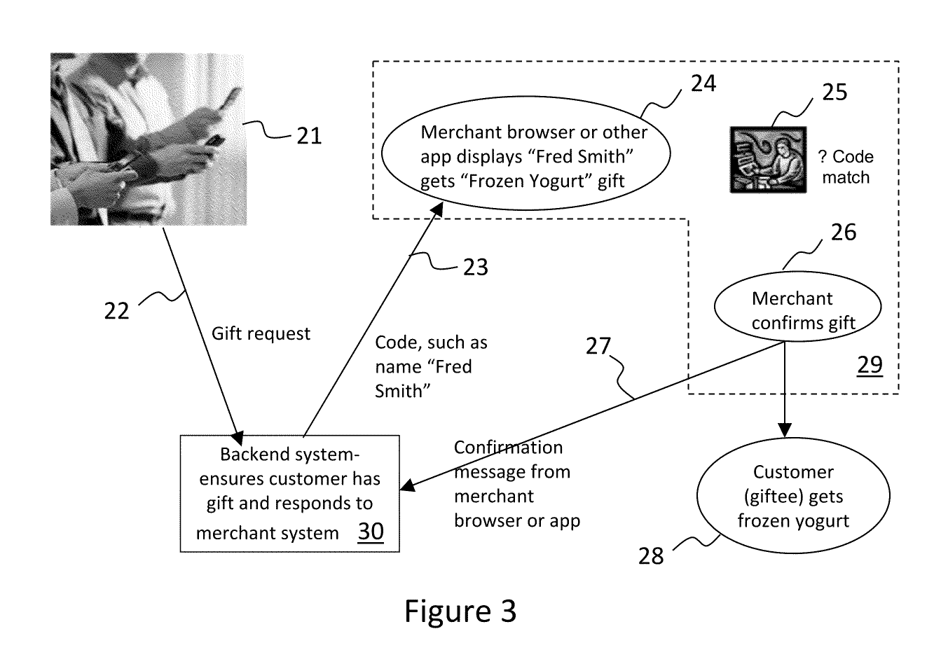

The merchant computer system may include a specialized application (sometimes termed an app) installed on the merchant's POS (Point-of-Sale) system, or a standard interface to the system, such as an Internet browser, to be able to receive a code from the gift management computer and software system, the backend system, in response to a selection of a gift by the giftor and a description of the gift in question, along with a quantity if applicable (e.g., 20 roses). In FIG. 3, this selection is represented by a picture 21 of smart phones in the hands of their presumptive owners. Illustrated by an arrow, the gift request 22 is sent from a smart phone (of the giftor) to the backend system 30.

Illustrated by another arrow, the code and gift description is delivered 23 in nearly real time, to the merchant computer system application or browser. In this embodiment, the giftee is simply asked to verify aspects of the code delivered to the merchant computer system (for example, the merchant may simply see the giftee's name, and ask the prospective giftee what their name is). Thus, the giftee need not possess an Internet-connected device but must be aware of the code or possess an attribute verifiable by the merchant from a code in the possession of the merchant. (In FIG. 3 the merchant operations are enclosed by a dotted line and labeled with the reference number 29.) The code is valid for a bounded, typically short, period of time, after which the application or browser no longer displays the code. Because there is a bounded window of time for which a code is valid and displayed, only a small number of currently available codes and gifts need be displayed, an illustrative example shown as oval 24, to a merchant—this minimizes the need for the merchant to search for a valid code. This is illustrated by the symbol 25 labeled “? Code match.”

The giftor selects his or her gift in a reasonably close time proximity to the expected redemption of the gift by giftee, since the code and gift description disappears if the gift is not confirmed quickly. The merchant must confirm the code/gift 26 with a simple gesture at the application or browser. This also generates a local (to the merchant computer system) audit trail (if enabled) so the merchant may have a local record of all gift redemption events. Upon confirmation the giftee can redeem the gift 28, as shown by the example of receiving some frozen yogurt from the merchant.

In the event there are multiple different currently-valid codes (even though the number is minimized as described earlier), the merchant must also select and confirm the specific matching code. However, this process is simplified by the choice of codes as described below. If the giftee does not redeem the gift quickly enough, the giftee may need to cause a new code to be sent to the merchant for confirmation. But the system recognizes stale codes and requests a new code if an attempt is made to confirm an expired code.

The giftee may optionally select the type of code transmitted to the merchant. This selection is typically made with the merchant Internet-connected device at the merchant store prior to requesting gift redemption. For example, a numeric code or dictionary word could be entered via a touch pad. Note that the code is only transmitted to the merchant computer system application or browser by the backend system so the code may be trusted by the merchant. The code could be the giftee's phone number, a short string of digits generated by the server, the giftee's name, a picture of the giftee, a key word (such as a favorite color), or any other convenient identifier or combination of the aforementioned items (such as name and picture), or a financial account number, such as a credit card PAN or bank account number (which may be generated by the backend server) belonging to the gift management system. The code need not be lengthy to be secure (since only the code management server can communicate codes to the merchant application, and only valid gift holders (giftees) can cause the transmission of the code via the aforementioned server or can or can otherwise be in possession of a code which is recognized as valid by the merchant (for example, in the case where the giftor causes transmission of a code directly to the merchant and giftee.). Note too that the giftee typically instigates the exchange of information by requesting the gift management system to deliver a code to the merchant which the merchant can trust given an authenticated connection to the gift management system—an automatic exchange of information, such as could be triggered by geographical proximity to a merchant, may not necessarily be a good thing because it could result in an excess of information displayed to the merchant that would require undesirable scrolling or searching for matching codes.

The code may be pulled into the merchant computer system interface via a gesture by the merchant (such as refreshing the screen or otherwise requesting the currently available codes) or pushed from the backend server to the merchant interface so that the merchant can always observe the currently valid codes. As stated above, the code may be specified by the giftee or by the system (potentially relying on data supplied by the giftor, such as the name of the giftee), depending upon configuration. For example, the system might automatically send the giftee's name; or the giftee might specify a sequence of digits. The giftee-specified code is, however, less secure since careless giftees using commonly known sequences are more likely to be exposed to theft in contrast to more secure system-generated codes or codes specific to a giftee such as a name.

The giftee may interact with the gift system in a variety of ways. This can include using an Internet-connected device available at the merchant and authenticating via this device. But more likely, a giftee's device, such as a cell phone or smart phone, is employed. If a smart phone is used, an application which is part of the present invention and supplied to the smart phone may narrow the current merchant identity using the GPS location capability of the phone. If an ordinary phone is employed, the giftee may be asked to identify the merchant in order to narrow the specification of the gift, or the giftee may pre-select the merchant/gift identity prior to visiting the merchant such that a simple call to a phone answering program connected to the system provided in the present invention can identify (possibly using the caller ID or ANI (Automatic Number Identification) of the customer phone) is sufficient to identify the gift to the merchant, and a pre-arranged code (such as the giftee's name or phone number) can be automatically transmitted to the application residing on the merchant computer system.

The current method can easily be integrated with other methods—for example, if the merchant does not possess an Internet-connected device, the giftee's phone can, upon identifying the merchant in question (possibly explicitly by name or specific merchant identifier, or possibly using GPS if available), determine if the current method is available at the merchant and fall back on other methods, such as described in the previously mentioned provisional patents.

Note too that should the giftee encounter difficulties (such as generating a code prematurely), the giftee can easily retry, even if the same code is re-used, since security is ensured by the application used by the merchant only being updated by the system of the present invention managed by the server managing gift redemption.

Malefactors trying to fill the merchant's display application with spurious codes are managed automatically because only valid giftees at a specific merchant are enabled to generate codes. The system may also include checks on the frequency of code generation at a specific merchant on behalf of a given giftee to further restrict attempts at meaningless code generation that can otherwise consume space on the displayed currently-available gifts.

Codes are broadcast to, or made available to pull at, all POS terminals at a given merchant location since the specific POS terminal used by a giftee may not be known at the time of redemption. However, as codes are valid for only a short time, the need for the merchant to scroll through many currently valid codes is minimized and scrolling may not even be necessary.

The gift description is transmitted to the POS along with the code. In some cases, the gift description may include a key which, when provided (manually or automatically) to the POS, automatically enters the gift into the merchant's POS or accounting system.

The browser or application used by the merchant may record (in the case of a browser, a browser plugin may be employed for this purpose; in the case of the app, this is a feature of the app) the confirmation result as part of an audit trail. Note that the backend system also records the confirmation event so that the merchant may be reimbursed for the gift by the gift management computer system if required.

The merchant is in control of issuing the gift and confirmation response to the backend system. If the code spoken or shown to the merchant by the customer does not match the code displayed to the merchant on the merchant's app or browser, as supplied by the backend system, the merchant may deny issuance of the gift. The confirmation also serves to ensure that duplicate gifts are not given, since a confirmation will fail if for any reason the gift has already been redeemed via a prior confirmation. The merchant may be (optionally) offered a chance to record a rejection if the code did not match. The backend system can use this information to further customer support assistance or determine patterns of abuse. The time and nature of every confirmation and rejection is recorded by the backend system.

In accordance with the described system and operations, random sequences of digits need not be compared, which is time-consuming and error-prone (e.g., a customer's name can simply be asked for to determine that it matches what is shown on the merchant application display). It is also apparent that the merchant does not need to scroll through many codes since the code is not sent automatically in advance of the customer redemption, but instead at the time of redemption. Because codes are only valid for a short period of time (after which, the space they occupy on the application screen is reclaimed), the need for scrolling is minimized or eliminated, which makes for rapid secure identification of the giftee and his or her entitled gift. It is also apparent that the present system supports multiple registers, does not require manual entry of codes, and does not require comparing random strings of digits or other non-familiar identifiers, and that the previously mentioned difficulties with challenge-response tokens are mitigated.

The present system can be used to track other aspects of a giftee visit. For example, a giftee might simply use the present system to record a visit to the store securely (as confirmed by the merchant) or the merchant can enter facts (such as total amount spent) about a giftee securely since the giftee's identity is securely (and anonymously, if desired—for example by transmitting a code of a short sequence of digits instead of a name) established. These facts can then be used as part of a loyalty mechanism where further rewards (which may include gifts, or which may include other offerings that are validated with the present mechanism or with other mechanisms) are made available to the giftee. As an example, a giftee who has recorded 3 or more visits securely with the merchant might receive notification from the gift system that the merchant has made a gift available to that giftee; the giftee can then go to the store and claim the gift using the present invention for the validation means.

### Employee And Merchant Training

In order to train employees and retailers how to use the aforementioned (or any other) validation mechanism, it is necessary to ensure that all employees of a retailer who interact with customers (giftees) are aware of an unfamiliar mechanism. To achieve this, the employer can provide to the system various means of identifying each relevant employee one or more of the following: 1) the list of employees who will need to use the mechanism by name; 2) the list of email addresses of these employees; 3) other contact information of each employee (such as phone number); 4) a unique code (which may be printed on a card for example) for each employee to used in the training as a code that is authorized to be transmitted to the merchant computer system upon request by the employee to the code management system; and 5) an emailed code (such as a unique URL) to a training site.

The system maintains this data and either actively requests that employees engage with the training material (in the case where contact information, such as email address is provided), or responds to and track requests for training

An employee views the training material at the training site, and be marked as having viewed it. Then, the employee may be given “training” validation means, such as described in the present application or in Provisional Pat. Nos. 61/568,825 or 61/487,886. For example, a “dummy” gift or gifts may be issued to a specific employee, and that employee's redemption of the gift proves that the employee has experienced the specific method of gift validation to which the dummy gift was associated. The merchant can be thus provided a list of employees, by name, who have demonstrated competency in specific validation methods. Employees who have demonstrated specific competencies may be awarded ‘badges’ that may be tangibly implemented (e.g., to sew onto a uniform), or to be represented virtually (for example, to be noted on an employer web site with a graphical distinction, or listed as being trained). Trained employees may also be rewarded with actual gifts to redeem.

It is readily apparent that aspects of the present training system can be applied to other areas of employee training; for example, where the set of employees who have viewed training materials is maintained by the system.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A computer system for implementing a gift validation service where a gift is purchased by a first party for a second party to be redeemed from a third party, comprising:
at least one processor coupled to at least one memory;
wherein the at least one processor is programmed to manage the validation of gifts purchase through the computer system by:
receiving a request from the second party to send a second party identification code for the gift to the third party;
sending an identification code for the second party to the third party;
receiving an indication from the third party that the gift has been redeemed; and
preparing remuneration to the third party.

2. The system of claim 1 wherein said identification code is a character string supplied by said second party.

3. The system of claim 1 wherein said identification code is a picture of said second party.

4. The system of claim 1 wherein said identification code is a character string supplied by said computer system to both said second party and said third party.

5. The system of claim 1 wherein said identification code is a PAN supplied by said second party.

6. The system of claim 1 wherein said identification code is a PAN supplied by said fourth party-managed computer system.

7. The system of claim 1 wherein said identification code is a PAN supplied by said first party.

8. The system of claim 1 wherein only a fixed number of most recent identification codes are displayed to said third party at any one time.

9. The system of claim 1 wherein said third party communicates with said computer system to indicate a validation was performed.

10. The system of claim 1 wherein the processor of PAN information provides information about a validation to said computer system.

11. The system of claim 1 wherein certain identification codes are bound to other information that can be tracked by said computer system.

12. The system of claim 11 wherein said other information is employed to facilitate employee training.

13. The system of claim 12 wherein said third party provides information about employee identity to said computer system so that said employees receive identification codes that can be distinguished from non-employee identification codes.

14. The system of claim 13 wherein said information about employee identity includes employee name.

15. The system of claim 13 wherein said information about employee identity includes employee email address.

16. The system of claim 13 wherein said information about employee identity includes employee social media identification information.

17. The system of claim 1 wherein greater than one currently valid gift for said second party are aggregated such that only a single validation need be performed by said third party to validate all currently valid gifts.

18. A computer system for implementing a gift validation service where a gift is purchased by a first party for a second party to be redeemed from a third party, comprising:
at least one processor coupled to at least one memory;
wherein the at least one processor is programmed to manage the validation of gifts purchased through the computer system by:
receiving a request from the first party to send a second party identification code for the gift to the third party;
sending an identification code for the second party to the third party;
receiving an indication from the third party that the gift has been redeemed; and
preparing remuneration to the third party.

19. The system of claim 18 wherein said identification code is a character string supplied by said first party.

20. The system of claim 18 wherein said identification code is a picture of said second party.

21. The system of claim 18 wherein only a fixed number of most recent identification codes are displayed to said third party at any one time.

22. The system of claim 18 wherein said third party communicates with said computer system to indicate a validation was performed.

23. The system of claim 18 wherein certain identification codes are bound to other information that can be tracked by said computer system.

24. The system of claim 18 wherein greater than one currently valid gift for said second party are aggregated such that only a single validation need be performed by said third party to validate all currently valid gifts.
